(19) United States
(12) Patent Application Publication
(10) Pub. No.: US 2007/0059221 A1
(43) Pub. Date: Mar. 15, 2007

(54) Test tube storage system

(76) Inventors: David Kelton Sorensen, (US); Leland Ritchie Crabb, (US)

Correspondence Address: Leland Ritchie Crabb, 2050 N Redmond Rd #98, Salt Lake City, UT, 84116, US

(21) Appl. No.: 11/222,381

(22) Filed: Sep. 9, 2005

(51) Int. Cl. B01L 9/00

(52) U.S. Cl. 422/104

(57) ABSTRACT

An apparatus and method is disclosed for conveniently storing test tubes. A rack defines a plurality of bays that receive test tubes, or like structures. One or more elastic members secure to the rack and are selectively placed over the test tubes to retain the test tubes. Fasteners may attach the elastic members to the rack while test tubes are being loaded or unloaded from the rack. A sealable pouch having a tear-away label and an external sleeve may store two racks for storage and transportation. A tear-away label may uniquely identify the pouch and serve to track and identify its contents.

### FIELD OF THE INVENTION

This invention relates to apparatus and methods for storing test tubes and more particularly to systems for storing test tubes during transportation.

### BACKGROUND

In modern medical practice it is common to extract or collect bodily fluids in order to test the fluids to detect the presence of chemicals, drugs, hormones, pathogens, or the like or otherwise analyze the fluids. Accordingly, a large number of test tubes must be collected and transported to the location where tests are to be performed. In some instances the tubes must be carried to another room, in others the tubes must be mailed to a different state.

In either case, the tubes must be secured against breakage. Prior systems typically include a cardboard structure, such as a box with apertures formed therein to receive the tubes. Some even provide a flap brought over the tubes to retain them within the structure. However, cardboard is essentially inelastic. Once the tubes are inserted into the cardboard structure, it typically has little capacity to exert any elastic biasing force to retain the tubes. Furthermore, test tubes are a mass produced item used and then discarded. Accordingly, test tubes are typically made to loose tolerances and often have different lengths. Systems providing a cardboard flap to cover the tubes cannot possibly adjust to the differing sizes, leaving the shorter tubes loose and easily shaken and damaged.

Accordingly, it would be an advancement in the art to provide an inexpensive structure capable of retaining test tubes of differing sizes. It would be a further advancement in the art to provide such a system that elastically retained the test tubes.

### BRIEF SUMMARY OF THE INVENTION

An invention is described herein providing an apparatus and method for conveniently and inexpensively retaining multiple test tubes during transportation. The apparatus may include a rack defining a plurality of bays sized to receive test tubes. In some applications, the rack is a cardboard structure forming a box having apertures formed in an upper side thereof. In some embodiments, the rack may define an internal spacer positioned within the box to retain the lower ends of test tubes.

A retaining member may be secured to the rack to retain the test tubes against movements. In some embodiments the retaining member is a sleeve sized to fit around the rack and test tubes to retain the test tubes. The elasticity of the sleeve enables the sleeve to conform to test tubes of differing lengths in order to secure the test tubes.

In an alternative embodiment, a plurality of elastic sleeves may be used to facilitate insertion and securement of test tubes within the rack. In one embodiment of the rack, the bays are arranged in rows and columns. Accordingly, a single sleeve may be sized to secure tubes inserted into a single row, or multiple rows, of bays. The sleeves may be permanently secured to the rack, such as by staples, glue, or the like.

### BRIEF DESCRIPTION OF THE DRAWINGS

The operation and functionality of the invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of a rack and test tubes, in accordance with the present invention;

FIG. 2 is a perspective view of a rack and test tubes having an elastic member secured thereto, in accordance with the present invention;

FIG. 3 is a perspective view of a rack and test tubes having multiple elastic members secured thereto, in accordance with the present invention;

FIG. 4 is a perspective view of a rack and test tubes having multiple elastic members positioned to permit insertion of test tubes, in accordance with the present invention;

FIG. 5 is a bottom view of a rack having fasteners securing the multiple elastic members thereto, in accordance with the present invention;

FIG. 6 is an exploded view of a rack, in accordance with the present invention;

FIG. 7 is a side view of a rack and insert, in accordance with the present invention;

FIG. 8 is a side view of a rack and insert during assembly or collapse of the rack, in accordance with the present invention;

FIG. 9 is a perspective view of a pouch suitable for storing the rack, in accordance with the present invention; and

FIG. 10 is a side view of a pouch storing multiple racks, in accordance with the present invention.

### DETAILED DESCRIPTION OF THE PREFERRED EMBODIMENTS

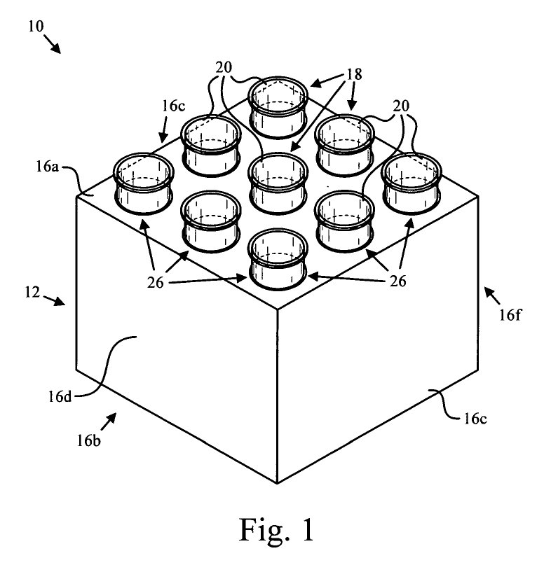

It will be readily understood that the components of the present invention, as generally described and illustrated in the Figures herein, may be arranged and designed in a wide variety of different configurations. Thus, the following more detailed description of the embodiments of the system and method of the present invention, as represented in FIGS. 1 through 6, is not intended to limit the scope of the invention, as claimed, but it is merely representative of the presently preferred embodiments of the invention.

The presently preferred embodiments of the invention will be best understood by reference to the drawings, wherein like parts are designated by like numerals throughout.

Those of ordinary skill in the art will, of course, appreciate that various modifications to the details illustrated in the schematic diagrams of FIGS. 1 through 10 may easily be made without departing from the essential characteristics of the invention. Thus, the following description is intended only as an example, and simply illustrates one presently preferred embodiment consistent with the invention as claimed herein.

Referring to FIG. 1, in certain embodiments an apparatus 10 may include a rack 12 formed to hold test tubes, vials, pipettes, or like vessels. The rack 12 may be embodied as a box 14 made of a thin, rigid material such as cardstock, cardboard, or like material. The box 14 may have an upper side 16a, a lower side 16b and four lateral sides 16c-16f. Various bays 18 may be formed in the rack 12 to receive test tubes 20, or like vessels 20. The bays 18 may be formed as apertures 22 formed in the upper side 16a of the box 14. The apertures 22 may be arranged in a variety of patterns. In the illustrated embodiments, the apertures 22 are arranged in rows 24 and columns 26 to maximize storage and facilitate identification of test tubes 20.

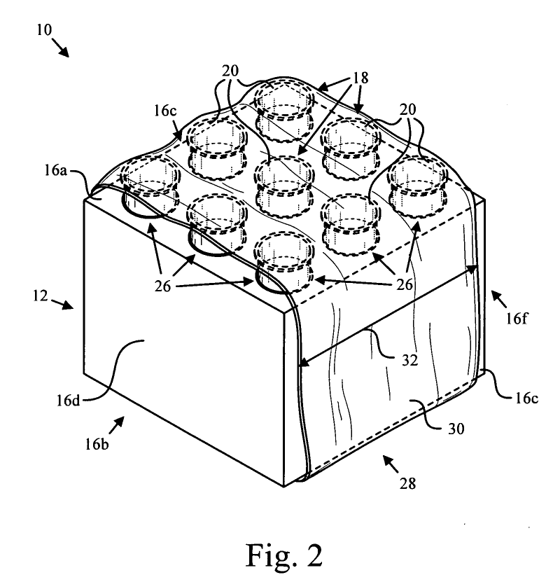

Referring to FIG. 2, a retainer 28 may be secured to the rack 12 to maintain the test tubes 20 within the bays 18. In the illustrated embodiment the retainer 28 is an elastic member 30, such as a sleeve 30, secured to the rack 12 such that it covers the bays 18 and test tubes 20. The sleeve 30 may substantially surround the rack 12. The sleeve 30 may be made of an elastic polymer, such as latex, capable of deforming to enable placement of the sleeve 30 around the rack 12 and test tubes 20 while providing a restoring force to retain the test tubes 20 within the bays 18. The sleeve 30 may have a width 32 sufficient to cover all rows 24 of apertures 22.

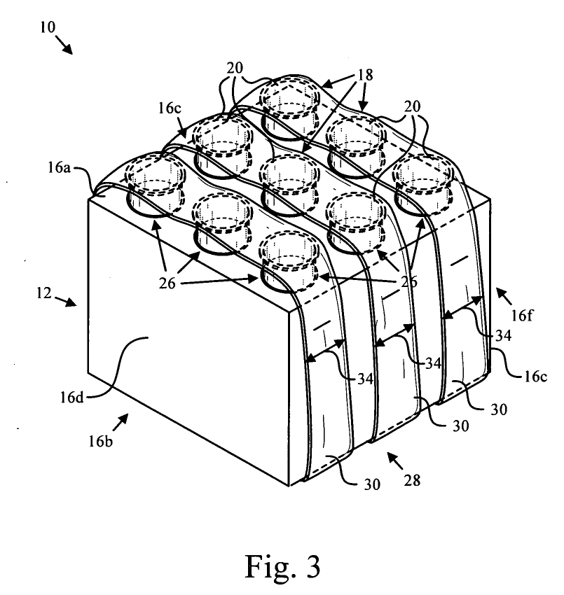

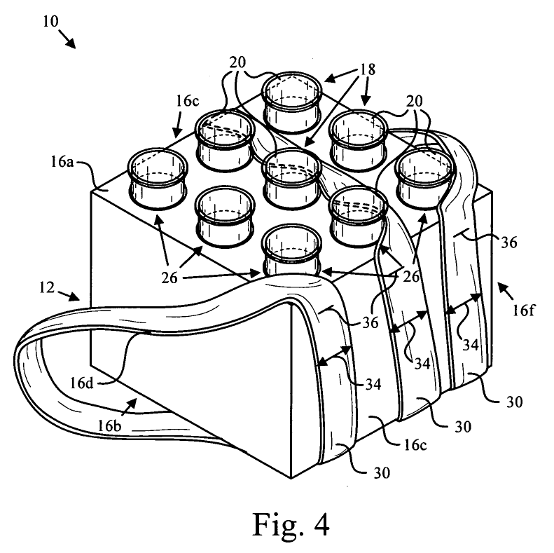

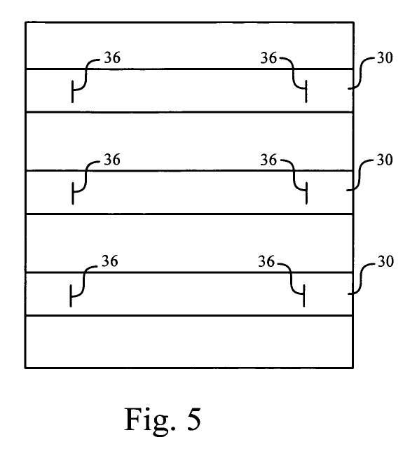

Referring to FIGS. 3 and 4, in some embodiments multiple sleeves 30a-30c each corresponding to a row 24 may be used to secure test tubes 20 within the bays 18. The sleeves 30a-30c may each have a width 34 sized to retain a single row of test tubes 20. In some embodiments the sleeves 30a-30c may be substantially permanently secured to the rack 12. Alternatively the sleeves 30a-30c may be secured to the rack 12 such that the sleeves are removable, and yet may remain secured while the sleeves 30a-30c are removed from retaining the test tubes 20. For example, as shown in FIG. 4, the sleeves 30a-30c are positioned away from the apertures 22, enabling test tubes 20 to be inserted therein. The sleeves 30a-30c may then be stretched and positioned over the tubes 20, as shown in FIG. 3, to retain the tubes 20 within the bays 18. Various types of fasteners 36 may be used, such as staples, glue, or retaining strips formed within the cardboard of the rack 12. In some embodiments, an adhesive compound may be used such as sticky polymer permitting ready release of the sleeves 30a-30c, or a glue permanently attaching the sleeves 30a-30c to the rack 12. For instance the fastener 36, or fasteners 36, may be a low tack double sided adhesive. The fasteners 36 may secure the sleeves 30a-30c to any one of the sides 16a-16f of the box 14. For example, in the embodiment of FIGS. 3 and 4, the fasteners 36 secures the sleeves 30a-30c to one lateral side 16c. In the embodiment of FIG. 5, the fasteners 36 secure the sleeves 30a-30c to the lower side 16b.

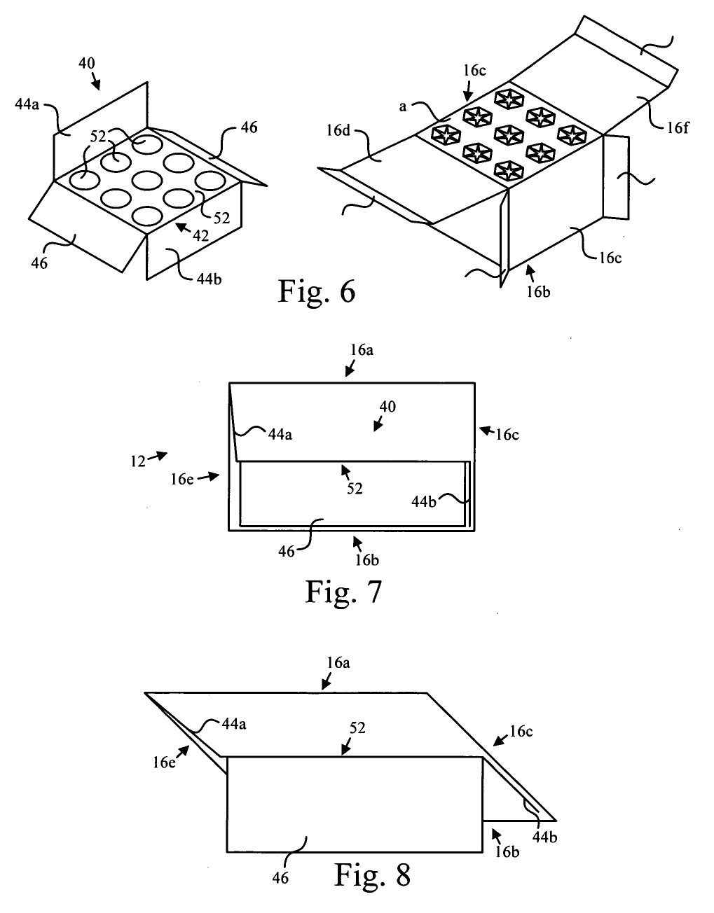

Referring to FIG. 6, a box 14 may be embodied as traditional boxes with flaps 38a-38d serving to lock the sides 16d,16f in position. In addition, in some embodiments, an insert 40 may be disposed within the box 14 to retain the lower ends of the test tubes 20 against movement. An insert may have a registration portion 42, spacer flaps 44a,44b, and retaining flaps 46. The registration portion 42 may serve, to define the bays 18 retaining the test tubes 20. In the illustrated embodiment, the registration portion 42 is embodied as apertures 50 formed in a central panel 52 of the insert 40.

The central panel 52 may be maintained within the box 14 spaced apart from both the upper and lower sides 16a,16b. Retaining flaps 44a,44b may secure to the sides 16c,16e as illustrated in FIG. 7 to maintain the central panel 52 in spaced apart relation to the sides 16a,16b. Support flaps 46 may likewise secure to the central panel 52 and be folded down into the position illustrated in FIG. 7 to support the edges of the central panel 52 not coupled to the box 14 by the retaining flaps 44a,44b.

Referring to FIG. 8, when shipping and storing the rack 12 it may be beneficial to disassemble the box 14 such that it may it is flat and takes up less space. Accordingly, the retaining flaps 44a,44b may be situated with one flap 44a positioned above the central panel 42 and the other flap 44b positioned below the central panel 42 such that the box may be skewed into a flat position as shown in FIG. 8. The support flaps 46 may be folded out of the way in order to permit skewing. It will be noted that in practice a box 14 is typically formed as a flat object and subsequently folded into a box. However, the process of forming the box is simply the reverse of the process of collapsing the box illustrated in FIG. 8. The flat structure is simply skewed, folding at the junctions of the side 16a,16b,16c,16f to create a box, with the insert following the movements of the box to arrive at the configuration of FIG. 7. The support flaps 46 may then be folded down as shown in FIG. 7.

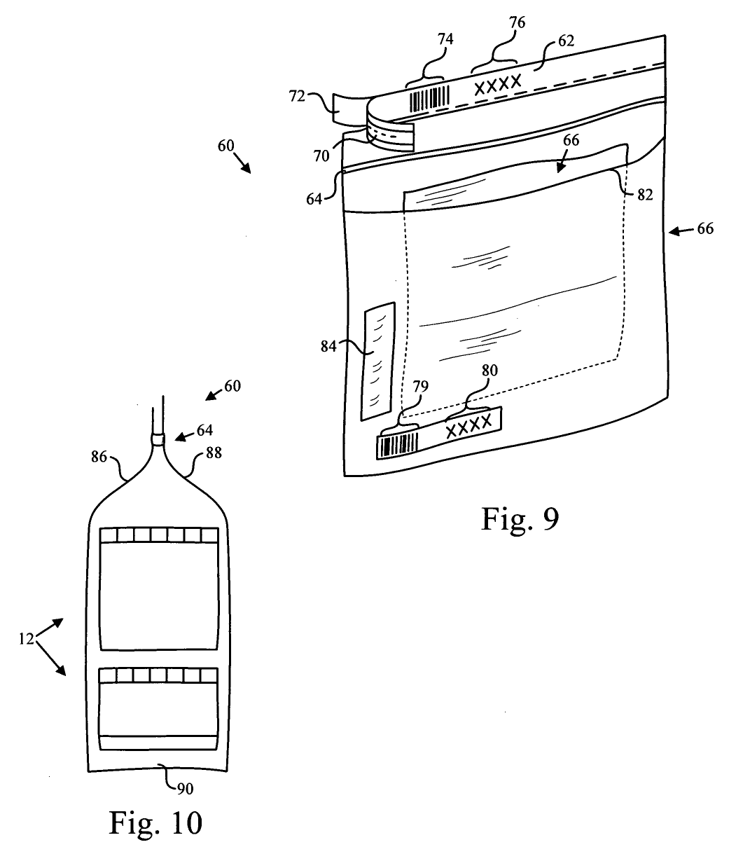

Referring to FIGS. 9 and 10, in some embodiments a rack 12, test tubes 20 and retainer 28 may be stored in a specialized pouch 60. A pouch 60 may include a label 62, a lock 64, a sealable chamber 66, and an exterior sleeve 68. The label 62 may be integrally secured to the pouch and be removable by means of a perforation 63. In some embodiments, the label 62 includes an adhesive 70 covered by backing 72. Thus, a user may tear the label off the pouch by means of the perforation 63, remove the backing 72, and adhere the label 62 to a document or the like. In some embodiments, the label 62 bears information such as bar code 74 and numbers 76. The bar code 74 may be printed in accordance with an indexing process such that during the production of a plurality of pouches 60, each pouch 60 will have a unique barcode 74 and bar code 79. The bar code 74 and numbers 76 of the label may be identical to a bar code 79 and numbers 80 printed on the sealable chamber 66 or exterior sleeve 68. In this manner, the label 62 corresponding to a particular pouch 60 is readily available for filing and identification purposes.

The exterior sleeve 68 may be formed as a sheet of material 82, typically the same material as the sealable chamber 66, secured to the sealable chamber 66 at its bottom and lateral sides, leaving the upper edge of the sheet 82 detached, thus defining an opening for the sleeve. The sleeve may serve to store documents and the like.

In some embodiments, an absorbent strip 84, or other material or structure having a like function, may be inserted into the sealable chamber 66 and absorb fluids that may leak from the test tubes 20.

Referring to FIG. 9, the lock 64 may be positioned at the upper edge of sheets 86 and 86 forming the sealable chamber 66. The lock 64 may be any means used to seal bags, such as a ZIPLOC type seal. The sheets 86, 88 may be sized such that the pouch 60 may store two racks 12 with their corresponding test tubes 20 and retainers 28. The sheets 86,88 may secure along their lateral sides to form the sealed chamber 66. A floor 90 may secure to the lower edges of the sheets 86,88 to further define the sealed chamber 66 and permit the chamber 66 to accommodate the width of the racks 12.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for storing test tubes, the apparatus comprising:
a rack defining a plurality of bays for receiving test tubes, the rack formed of a rigid, substantially inelastic material;
at least one tube inserted into a bay;
at least one elastic member secured to the rack and selectively disposed over the tube to retain the tube within the bay.

2. The apparatus of claim 1, wherein the elastic member substantially surrounds the rack.

3. The apparatus of claim 2, wherein the rack is a box and wherein the bays are apertures formed in an upper side of the box, the bays arranged in rows and columns.

4. The apparatus of claim 3, comprising elastic members corresponding to each row of bays.

5. The apparatus of claim 4, wherein the elastic members are permanently secured to the rack.

6. The apparatus of claim 4, wherein a substantially small portion of each elastic member is substantially permanently attached to the rack.

7. The apparatus of claim 1, wherein the at least one elastic member is a band of elastic material formed in closed loops.

8. An apparatus for storing test tubes, the apparatus comprising:
a rack defining a plurality of bays for receiving test tubes, the rack formed of a rigid, substantially inelastic material;
at least one tube inserted into a bay;
an elastic sleeve selectively placed over the rack to retain the tube within the bay.

9. The apparatus of claim 8, wherein the rack is a box and wherein the bays are apertures formed in an upper side of the box, the bays arranged in rows and columns.

10. The apparatus of claim 8, further comprising multiple elastic sleeves corresponding to each row of bays.

11. The apparatus of claim 10, wherein the elastic sleeves are substantially permanently secured to the box in substantial alignment with the rows.

12. The apparatus of claim 11, wherein only a substantially small portion of each elastic member is substantially permanently attached to the rack.

13. The apparatus of claim 10, further comprising fasteners each attaching an elastic sleeves to the rack when the elastic sleeves are not placed over the rack.

14. An apparatus for storing test tubes, the apparatus comprising:
a plurality of racks, each defining a plurality of bays for receiving test tubes and formed of a rigid, substantially inelastic material
a plurality of tubes inserted into the plurality of bays;
at least one elastic member secured to each rack and selectively disposed over the tubes to retain the tubes within the bay.
a pouch having having a seal at the top thereof to selectively seal an opening thereof, the pouch sized to receive the racks and containing a piece of absorbent material.

15. The pouch of claim 14, wherein the pouch further comprising a tear-away label removably secured to the pouch above the seal, the label having identification information printed thereon, the bag further comprising information printed thereon identical to the information identification information printed on the label.

16. The pouch of claim 14, further comprising an external sleeve.
